(19) United States
(12) Patent Application Publication
(10) Pub. No.: US 2024/0110131 A1
(43) Pub. Date: Apr. 4, 2024

(54) ENHANCED ENZYMATIC CLEANER FOR MEMBRANES AND METHOD OF CLEANING THEREOF

(71) Applicants: BL TECHNOLOGIES, INC., Minnetonka, MN (US); NOVOZYMES A/S, Bagsvaerd (DK)

(72) Inventors: Jian An HAO, Beijing (CN); Henrik Bangsoe NIELSEN, Bagsvaerd (DK); Agata ZAREBSKA, Bagsvaerd (DK); Gernot J. ABEL, Bagsvaerd (DK); Hongyi YANG, Beijing (CN); Yafang WANG, Beijing (CN); Jeffrey MELZER, Minnetonka, MN (US); Xingpeng ZHANG, Minnetonka, MN (US)

(21) Appl. No.: 18/275,395

(22) PCT Filed: Feb. 9, 2022
(86) PCT No.: PCT/CN2022/075640

§ 371 Date: Aug. 1, 2023

(30) Foreign Application Priority Data
Feb. 10, 2021 (WO) PCT/CN2021/076453

(51) Int. Cl. C11D 3/386

(52) U.S. Cl. CPC C11D 3/38636; C11D 3/38618; C11D 2111/12

(57) ABSTRACT

A method for cleaning a water filtration membrane, the method having at least an alkaline cleaning step, wherein the method includes a first enzyme solution comprising a polypeptide having carbohydrase activity, and a second enzyme solution comprising a polypeptide having protease activity.

### FIELD OF INVENTION

The disclosed technology provides for a method to provide the effective cleaning of membranes, and more specifically, a method to provide an effective and milder cleaning of membranes by combining specific enzymes with chemical cleansers.

### REFERENCE TO A SEQUENCE LISTING

This application contains a Sequence Listing in computer readable form, which is incorporated herein by reference.

### BACKGROUND OF THE INVENTION

Membrane fouling is a problem encountered in membrane filtration processes, including reverse osmosis (RO), ultrafiltration (UF), and nano-filtration (NF) processes, and is a major factor in determining their practical application in water and wastewater treatment, as well as desalination in terms of technology and economics. Membrane fouling can occur on all membrane surfaces including inside any pores and reduces permeate flow and salt rejection.

Typically, membranes are used for as long as they have the required permeability (measured by flux), or permeate quality (measured by the membranes ability to reject ions), or a reasonable energy operating cost (indirectly measured by pressure losses). However, once the membrane exhibits decreased yield, transmembrane pressure for UF units or differential pressure for RO and NF units (DP), or ions crossing in RO and NF membranes increase to an unacceptable level (e.g. as determined by internal or industry standards), the membrane must be replaced or cleaned.

However, the replacement of membranes represents a considerable cost to industry, since new membranes are expensive and a process line using membrane modules must be shut down while new membranes are installed. Furthermore, fouled membranes are costly to dispose of in landfill and also represent a negative environmental impact.

To reduce the impact of these degradation processes, chemical treatment methods of membranes typically include: pretreatment with coagulants and/or polymers, and treatment with antiscalants, biocides, and/or cleaning products.

Depending on the type of membrane, chemicals used in cleaners could include products such as, for example in Ultrafiltration systems (UF), sodium hypochlorite or citric acid and surfactants. For Reverse Osmosis (RO) and Nano Filtration (NF), cleaners could include mineral and/or organic acids, caustic soda, chelants like sodium EDTA, and surfactants.

Cleaning processes can have a negative impact on the membrane that impacts its filtration capacity. Cleaning frequency mainly depends on the rate and type of foulants that build up from the water chemistry being processed, and plant operating conditions. Cleaning frequency could range from once per quarter, to once per week or in extreme cases, once per day. In any case, frequent chemical cleaning of membranes is costly due to the loss in system operation time, productivity of the unit, labor cost, decreased life expectancy of the membranes, and consumption of cleaning chemicals, which may have environmental impact. In some situations, where cleaning is more frequent, cleaning processes may include the usage of higher chemical concentration. In other situation where cleaning is less frequent, regular cleaning processes may include even more intensive chemical cleaning regime with a significant negative effect on membrane lifespan.

Membranes, including, for example, RO-membranes are significantly impacted by biofouling which leads to lowered efficiency and deterioration of the membranes. Thus, cleaning of membranes is an integrated part of the operation of water filtration plants, a procedure that requires the use of harsh chemicals. In a majority of fouled RO-membranes that have to be removed from service due to an inability to produce expected water yield at the right quality permeate, biofouling is identified as the primary foulant.

To reduce the need to replace membranes due to fouling and the associated operational cost increases, periodic clean-in-place (CIP) operations are conducted to remove foulants from membranes surfaces. A typical CIP cycle will often include the use of chemicals for high pH (e.g., NaOH), low pH (e.g., citric acid or phosphoric acid), water, surfactants and in some cases biocides for disinfection, e.g., peracetic acid. However, use of such harsh chemicals in CIP methods is undesirable and poses a problem to the environment.

Traditionally, alkaline cleaners are primarily used to remove biofouling, often in a multistep process that alternates between some combination of alkaline cleaning, rinsing, acid cleaning and a final rinse. Alkaline cleaners typically are used at pH>11, which over time and with repeated cleaning operations can cause damage to membranes (RO, NF and UF). In extreme cases, oxidizing cleaners are used to further enhance cleaner efficacy. However, the oxidizing power of the cleaner can further exacerbate damage to the membrane.

Thus, what is needed in the art is a method that overcomes these disadvantages and provides an effective and milder cleaning of membranes.

### SUMMARY OF THE INVENTION

The disclosed technology provides for a method for cleaning a water filtration membrane. In one aspect of the disclosed technology, the method comprises at least an alkaline cleaning step, wherein the method includes a first enzyme solution comprising a polypeptide having carbohydrase activity, and a second enzyme solution comprising a polypeptide having protease activity.

In some embodiments, the method further comprises an acidic cleaning step performed prior to the alkaline cleaning step.

In some embodiments, the first enzyme solution is added to the acidic cleaning step, and the second enzyme solution is added to the alkaline cleaning step. In some embodiments, the first enzyme solution and second enzyme solutions are added to the alkaline cleaning step. In some embodiments, the membrane is contacted with about 50 ppm to about 2000 ppm of the second enzyme solution.

In some embodiments, the acidic cleaning step is performed at a pH of about 2 to about 6, and in other embodiments, the acidic cleaning step is performed at a pH of about 3 to 6.

In some embodiments, the alkaline cleaning step is performed at a pH of about 8 to about 11, and in other embodiments, the alkaline cleaning step is performed at a pH of about 8 to 10.

In some embodiments, the first enzyme solution comprises one or more enzyme selected from the group consisting of SEQ ID NO: 1, SEQ ID NO: 2, SEQ ID NO: 3, SEQ ID NO: 4, SEQ ID NO: 5, SEQ ID NO: 6, and SEQ ID NO: 7. In some embodiments, the first enzyme solution comprises one or more enzyme selected from the group consisting of SEQ ID NO: 1, SEQ ID NO: 2, SEQ ID NO: 3, and SEQ ID NO: 4.

In some embodiments, the second enzyme solution is selected from the group consisting of SEQ ID NO: 8, SEQ ID NO: 9, SEQ ID NO: 10, SEQ ID NO: 11, and SEQ ID NO: 12.

In some embodiments, the acidic cleaning step comprises contacting the membrane with a cleaning agent; contacting the membrane with a buffer at pH 2 to 6; and contacting the membrane with the first enzyme solution.

In some embodiments, the alkaline cleaning step comprises contacting the membrane with a cleaning agent; contacting the membrane with a buffer with a pH of about 8 to about 11; and contacting the membrane with the second enzyme solution.

In some embodiments, the cleaning agent comprises a chemical surfactant. In some embodiments, the membrane is contacted with about 50 ppm to about 2000 ppm of the first enzyme solution. In some embodiments, the membrane comprises a RO, NF, or UF membrane.

In some embodiments, the cleaning agent comprises glycolic acid, phosphonic acid, formic acid, citric acid, sulfonic acid, sulphamic acid, acetic acid, nitric acid, phosphoric acid, and/or combinations thereof. In some embodiments, about 2,500 ppm to about 30,000 ppm of the cleaning agent is provided to the membrane.

In some embodiments, the chemical surfactant comprises a non-ionic or an ionic surfactant. In some embodiments, the non-ionic surfactant comprises an alcohol ethoxylated surfactant selected from the group consisting of alcohol alkoxylates, amine oxide, alkaneamide, phosphate esters, ethoxylates alcohols and ethoxylated propoxylated alcohols. In some embodiments, the ionic surfactant comprises a sulfonated surfactant selected from the group consisting of alkyl sulfonate, alkylbenzene sulfonates, alkylbenzene sulfonic acids, alkyldiphenyl-oxide disulfonate salts, phosphate esters, alkyl ether sulfates, alkyl sulfates, and alkyl ether sulphosuccinates.

In some embodiments, the cleaning agent further comprises a sequestration agent. In some embodiments, the sequestration agent comprises trisodium phosphate (TSP), tetra potassium pyrophosphate (TKPP), hexametaphosphate (HMP), Ethylenediamine-N,N′-disuccinic acid (EDDS), Ethylenediaminetetraacetic acid (EDTA), Hydroxyethylethylenediaminetriacetic acid (HEDTA), gluconic acid/gluconates, and/or combinations thereof.

In some embodiments, the first enzyme solution and the second enzyme solution are provided to a water filtration membrane as a mixture. In some embodiments, the water filtration membrane is a RO, NF, or UF membrane.

In yet another aspect of the disclosed technology, a membrane cleaner is provided. In some embodiments, the membrane cleaner comprises a chemical cleaner comprising a surfactant; a first enzyme solution comprising a polypeptide having carbohydrase activity; a second enzyme solution comprising a polypeptide having protease activity; and a buffer having an alkaline pH.

In some embodiments, the membrane cleaner further comprises a buffer having an acidic pH.

In some embodiments, the first enzyme solution and the buffer having an alkaline pH are a mixture. In some embodiments, the first enzyme solution, the second enzyme solution, and the buffer are a mixture. In some embodiments, the first enzyme solution and the buffer having an acidic pH are a mixture.

In some embodiments, the first enzyme solution comprises one or more enzyme selected from the group consisting of SEQ ID NO: 1, SEQ ID NO: 2, SEQ ID NO: 3, SEQ ID NO: 4, SEQ ID NO: 5, SEQ ID NO: 6, and SEQ ID NO: 7. In some embodiments, the first enzyme solution comprises one or more enzyme selected from the group consisting of SEQ ID NO: 1, SEQ ID NO: 2, SEQ ID NO: 3 and SEQ ID NO: 4.

In some embodiments, the second enzyme solution is selected from the group consisting of SEQ ID NO: 8, SEQ ID NO: 9, SEQ ID NO: 10, SEQ ID NO: 11, and SEQ ID NO: 12.

### BRIEF DESCRIPTION OF THE DRAWINGS

These and other features of the disclosed technology, and the advantages, are illustrated specifically in embodiments now to be described, by way of example, with reference to the accompanying diagrammatic drawings, in which:

FIG. 1 is table providing the disclosed carbohydrase and protease numbers, and their correlated SEQ ID's as disclosed in the present technology;

FIG. 2 is a graph providing results of an illustrative embodiment of the disclosed technology;

FIG. 3 is a graph providing results of an illustrative embodiment of the disclosed technology;

FIG. 4 is a graph providing results of an illustrative embodiment of the disclosed technology;

FIG. 5 is a graph providing results of an illustrative embodiment of the disclosed technology;

FIG. 6 is a graph providing results of an illustrative embodiment of the disclosed technology;

FIG. 7 is a graph providing results of an illustrative embodiment of the disclosed technology;

FIGS. 8A-8B are graphs providing results of illustrative embodiments of the disclosed technology;

FIG. 9A is a graph providing results of an illustrative embodiment of the disclosed technology;

FIGS. 9B-9C are photographs of a membrane as it relates to illustrative embodiments of the disclosed technology;

FIG. 10 is a graph providing results of an illustrative embodiment of the disclosed technology; and

FIGS. 11A-11B are graphs providing results of illustrative embodiments of the disclosed technology.

### SEQUENCES

SEQ ID NO: 1: is a polypeptide having endo-1,3(4)-beta-glucanase activity from Aspergillus aculeatus. Carbohydrase 1 contains SEQ ID NO: 1.

SEQ ID NO: 2: is a polypeptide having pectin methylesterase activity from Aspergillus aculeatus. Carbohydrase 1 contains SEQ ID NO: 2.

SEQ ID NO: 3: is a polypeptide having endo-polygalacturonase activity from Aspergillus aculeatus. Carbohydrase 1 contains SEQ ID NO: 3.

Carbohydrase 1 comprises one or more of SEQ ID NO: 1, SEQ ID NO: 2, and SEQ ID NO: 3. For example, in some embodiments, Carbohydrase 1 comprises two or more of SEQ ID NO: 1, SEQ ID NO: 2, or SEQ ID NO: 3, and in other embodiments, Carbohydrase 1 comprises SEQ ID NO: 1, SEQ ID NO: 2, and SEQ ID NO: 3.

SEQ ID NO: 4: is a polypeptide having endo-inulinase activity from Aspergillus niger.

SEQ ID NO: 5: is a polypeptide having pectin lyase activity from Aspergillus niger. Carbohydrase 8 contains SEQ ID NO: 5.

SEQ ID NO: 6: is a polypeptide having polygalacturonase activity from Aspergillus niger. Carbohydrase 8 contains SEQ ID NO: 6.

SEQ ID NO: 7: is a polypeptide having pectate lyase activity from Bacillus subtilis. SEQ ID NO: 7 is referred to as Carbohydrase 11 throughout the specification.

SEQ ID NO: 8: is a polypeptide having serine protease activity from Nocardiopsis sp. SEQ ID NO: 8 is referred to as Protease 5 throughout the specification.

SEQ ID NO: 9: is a polypeptide having Dipeptidylaminopeptidase (DPAPI) activity from Aspergillus oryzae. SEQ ID NO: 9 is referred to as Protease 6 throughout the specification.

SEQ ID NO: 10: is a polypeptide having serine endoprotease activity from Alkalihalobacillus clausii. SEQ ID NO: 10 is referred to as Protease 12 throughout the specification.

SEQ ID NO: 11: is a polypeptide having serine endoprotease activity from Bacillus lentus. SEQ ID NO: 11 is referred to as Protease 28 throughout the specification.

SEQ ID NO: 12: is a polypeptide having serine endoprotease activity from Alkalihalobacillus clausii. SEQ ID NO: 12 is referred to as Protease 30 throughout the specification.

### DETAILED DESCRIPTION OF EXEMPLARY EMBODIMENTS

The disclosed technology provides for a method to provide effective cleaning of membranes, and more specifically, a method to provide an effective and milder cleaning of membranes by combining specific enzymes with chemical cleansers.

The disclosed technology provides for enzymatic additives which accomplish and/or improve upon the level of cleaning achieved by conventional alkaline or oxidizing-based membrane cleaners. The method as disclosed herein provides a milder pH (e.g. ˜9.1) cleaning, thereby eliminating the detrimental properties of the CIP procedure and essentially results in longer membrane life and reduces the need to replace membrane elements. Lower cleaner chemical usage (e.g. 2% vs. 0.5%) can be achieved with the catalytic effect of the specific enzymes disclosed, thus reducing the impact of effluent from the CIP on the environment. Additionally, better surface foulant removal helps extend membrane operating time, reduces the pressure drop, and potentially lowers the CIP frequency. The disclosed method also provides for the ease of cleaning solution discharge (i.e. with a near-neutral CIP solution) without necessary neutralization.

In one aspect of the disclosed technology, a method for cleaning a water filtration membrane is provided. It should be understood that the water filtration membrane as disclosed herein may comprise a RO, NF, or UF membrane. The method comprises at least an alkaline cleaning step, wherein a first enzyme solution comprising a polypeptide having carbohydrase activity is contacted with a membrane, and a second enzyme solution comprising a polypeptide having protease activity is contacted with a membrane. In some embodiments, the method further comprises an acidic cleaning step. It should be understood that in some embodiments, the alkaline cleaning step occurs prior to the acidic cleaning step, and in other embodiments, the acidic cleaning step occurs prior to the alkaline cleaning step.

In some embodiments, the first enzyme solution and second enzyme solutions are added to the alkaline cleaning step. In some embodiments, the membrane is contacted with about 50 ppm to about 2000 ppm of the said first enzyme solution. In some embodiments, the membrane is contacted with about 50 ppm to about 2000 ppm of the second enzyme solution. In other embodiments, the first enzyme solution and the second enzyme solution are provided to a water filtration membrane as a mixture.

Sequence identity: The relatedness between two amino acid sequences or between two nucleotide sequences is described by the parameter “sequence identity”.

For purposes of the present invention, the sequence identity between two amino acid sequences is determined as the output of “longest identity” using the Needleman-Wunsch algorithm (Needleman and Wunsch, 1970, J. Mol. Biol. 48: 443-453) as implemented in the Needle program of the EMBOSS package (EMBOSS: The European Molecular Biology Open Software Suite, Rice et al., 2000, Trends Genet. 16: 276-277), preferably version 6.6.0 or later. The parameters used are a gap open penalty of 10, a gap extension penalty of 0.5, and the EBLOSUM62 (EMBOSS version of BLOSUM62) substitution matrix. In order for the Needle program to report the longest identity, the nobrief option must be specified in the command line. The output of Needle labeled “longest identity” is calculated as follows: (Identical Residues×100)/(Length of Alignment−Total Number of Gaps in Alignment).

For purposes of the present invention, the sequence identity between two polynucleotide sequences is determined as the output of “longest identity” using the Needleman-Wunsch algorithm (Needleman and Wunsch, 1970, supra) as implemented in the Needle program of the EMBOSS package (EMBOSS: The European Molecular Biology Open Software Suite, Rice et al., 2000, supra), preferably version 6.6.0 or later. The parameters used are a gap open penalty of 10, a gap extension penalty of 0.5, and the EDNAFULL (EMBOSS version of NCBI NUC4.4) substitution matrix. In order for the Needle program to report the longest identity, the nobrief option must be specified in the command line. The output of Needle labeled “longest identity” is calculated as follows: (Identical Deoxyribonucleotides×100)/(Length of Alignment−Total Number of Gaps in Alignment).

In some embodiments, the first enzyme solution is selected from the group consisting of SEQ ID NO: 1, SEQ ID NO: 2, SEQ ID NO: 3, and SEQ ID NO: 4.

In some embodiments, the first enzyme solution comprises at least one polypeptide having carbohydrase activity selected from the group consisting of an endo-1,3(4)-beta-glucanase (EC Number 3.2.1.6), a pectin methyl esterase (EC Number 3.1.1.11), an endo-inulinase (EC Number 3.2.1.7), a pectin lyase (EC Number 4.2.2.10), a pectinase (EC Number 3.2.1.15) and a polygalacturonase (EC Number 4.2.2.2).

In some embodiments, the first enzyme solution comprises a carbohydrase which may be a multi-component enzyme mix, comprising at least one polypeptide having carbohydrase activity selected from the group consisting of an endo-1,3(4)-beta-glucanase, a pectin methyl esterase, an endo-inulinase, a pectin lyase, a pectinase, a pectate lyase and a polygalacturonase.

In some embodiments, the first enzyme solution comprises a carbohydrase which may be a multi-component enzyme mix, comprising at least two polypeptides, such as at least three polypeptides, having carbohydrase activity selected from the group consisting of an endo-1,3(4)-beta-glucanase, a pectin methyl esterase, an endo-inulinase, a pectin lyase, a pectinase, a pectate lyase and a polygalacturonase. In some embodiments, the first enzyme solution comprises a carbohydrase which is multi-component enzyme mix comprising endo-1,3(4)-beta-glucanase, a pectin methyl esterase, and a polygalacturonase. In other embodiments, the first enzyme solution comprises a carbohydrase which is multi-component enzyme mix comprising endo-1,3(4)-beta-glucanase, a pectin methyl esterase, and a polygalacturonase.

In some embodiments, the first enzyme solution comprises a carbohydrase which may be a mono-component comprising an endo-1,3(4)-beta-glucanase, a pectin methyl esterase, an endo-inulinase, a pectin lyase, a pectinase, a pectate lyase, or a polygalacturonase.

In some embodiments, the first enzyme solution comprises a carbohydrase wherein the carbohydrase is an endo-inulinase. In such embodiments, the enzyme hydrolyses the endo-linkages of inulin, which is a linear β-2,1-linked fructose polymer initiated by a glucose unit. Inulin is thereby broken down to oligosaccharides with a degree of polymerisation between 2 and 8. The endo-inulinase may be produced by submerged pure culture fermentation of a production strain of Aspergillus niger, coding for the polypeptide.

In some embodiments, the first enzyme solution comprises a carbohydrase wherein the carbohydrase is a multicomponent mixture of enzymes comprising endo-1,3(4)-beta-glucanase and pectin methyl esterase and optionally one or more pectinases.

In some embodiments, the first enzyme solution comprises a carbohydrase wherein the carbohydrase is a multicomponent mixture of enzymes comprising pectin lyase and polygalacturonase.

In some embodiments, the first enzyme solution comprises a carbohydrase which is multi-component enzyme mix comprising endo-1,3(4)-beta-glucanase, a pectin methyl esterase, and a polygalacturonase. In some embodiments, the first enzyme solution comprises a carbohydrase which is multi-component enzyme mix obtainable from Aspergillus aculeatus comprising endo-1,3(4)-beta-glucanase, a pectin methyl esterase, and a polygalacturonase.

In some embodiments, the first enzyme solution comprises one or more polypeptides selected from the group consisting of SEQ ID NO: 1, SEQ ID NO: 2, and SEQ ID NO: 3; in some embodiments, two or more polypeptides selected from the group consisting of SEQ ID NO: 1, SEQ ID NO: 2, and SEQ ID NO: 3; and in other embodiments, Carbohydrase 1 comprises SEQ ID NO: 1, SEQ ID NO: 2, and SEQ ID NO: 3.

In some embodiments, the first enzyme solution comprises one or more polypeptides obtainable from Aspergillus aculeatus selected from the group consisting of SEQ ID NO: 1, SEQ ID NO: 2, and SEQ ID NO: 3; in some embodiments, two or more polypeptides obtainable from Aspergillus aculeatus selected from the group consisting of SEQ ID NO: 1, SEQ ID NO: 2, and SEQ ID NO: 3; and in other embodiments, Carbohydrase 1 comprises SEQ ID NO: 1, SEQ ID NO: 2, and SEQ ID NO: 3 obtainable from Aspergillus aculeatus.

In some embodiments, the first enzyme solution comprises a carbohydrase wherein the carbohydrase is an endo-1,3(4)-beta-glucanase having at least 80% sequence identity to SEQ ID NO: 1, such as at least 85% sequence identity, such as at least 90% sequence identity, such as at least 91% sequence identity, such as at least 92% sequence identity, such as at least 93% sequence identity such as at least 94% sequence identity, such as at least 95% sequence identity, such as at least 96% sequence identity, such as at least 97% sequence identity, such as at least 98% sequence identity, such as at least 99% sequence identity, such as 100% sequence identity to SEQ ID NO: 1.

In some embodiments, the first enzyme solution comprises a carbohydrase wherein the carbohydrase is a pectin methyl esterase, having at least 80% sequence identity to SEQ ID NO: 2, such as at least 85% sequence identity, such as at least 90% sequence identity, such as at least 91% sequence identity, such as at least 92% sequence identity, such as at least 93% sequence identity such as at least 94% sequence identity, such as at least 95% sequence identity, such as at least 96% sequence identity, such as at least 97% sequence identity, such as at least 98% sequence identity, such as at least 99% sequence identity, such as 100% sequence identity to SEQ ID NO: 2.

In some embodiments, the first enzyme solution comprises a carbohydrase wherein the carbohydrase is a pectinase, having at least 80% sequence identity to SEQ ID NO: 3, such as at least 85% sequence identity, such as at least 90% sequence identity, such as at least 91% sequence identity, such as at least 92% sequence identity, such as at least 93% sequence identity such as at least 94% sequence identity, such as at least 95% sequence identity, such as at least 96% sequence identity, such as at least 97% sequence identity, such as at least 98% sequence identity, such as at least 99% sequence identity, such as 100% sequence identity to SEQ ID NO: 3.

In some embodiments, the first enzyme solution comprises a carbohydrase wherein the carbohydrase is a endo-inulinase, having at least 80% sequence identity to SEQ ID NO: 4, such as at least 85% sequence identity, such as at least 90% sequence identity, such as at least 91% sequence identity, such as at least 92% sequence identity, such as at least 93% sequence identity such as at least 94% sequence identity, such as at least 95% sequence identity, such as at least 96% sequence identity, such as at least 97% sequence identity, such as at least 98% sequence identity, such as at least 99% sequence identity, such as 100% sequence identity to SEQ ID NO: 4. In some embodiments, the first enzyme solution comprises a carbohydrase wherein the carbohydrase is an endo-inulinase obtainable from Aspergillus niger and having at least 80% sequence identity to SEQ ID NO: 4.

In some embodiments, the first enzyme solution comprises a carbohydrase wherein the carbohydrase is a pectin lyase, having at least 80% sequence identity to SEQ ID NO: 5, such as at least 85% sequence identity, such as at least 90% sequence identity, such as at least 91% sequence identity, such as at least 92% sequence identity, such as at least 93% sequence identity such as at least 94% sequence identity, such as at least 95% sequence identity, such as at least 96% sequence identity, such as at least 97% sequence identity, such as at least 98% sequence identity, such as at least 99% sequence identity, such as 100% sequence identity to SEQ ID NO: 5. In some embodiments, the first enzyme solution comprises a carbohydrase wherein the carbohydrase is a pectin lyase obtainable from Aspergillus niger and having at least 80% sequence identity to SEQ ID NO: 5.

In some embodiments, the first enzyme solution comprises a carbohydrase wherein the carbohydrase is a polygalacturonase, having at least 80% sequence identity to SEQ ID NO: 6, such as at least 85% sequence identity, such as at least 90% sequence identity, such as at least 91% sequence identity, such as at least 92% sequence identity, such as at least 93% sequence identity such as at least 94% sequence identity, such as at least 95% sequence identity, such as at least 96% sequence identity, such as at least 97% sequence identity, such as at least 98% sequence identity, such as at least 99% sequence identity, such as 100% sequence identity to SEQ ID NO: 6. In some embodiments, the first enzyme solution comprises a carbohydrase wherein the carbohydrase is a polygalacturonase obtainable from Aspergillus niger and having at least 80% sequence identity to SEQ ID NO: 6.

In some embodiments, the first enzyme solution comprises a carbohydrase wherein the carbohydrase is a pectate lyase, having at least 80% sequence identity to SEQ ID NO: 7, such as at least 85% sequence identity, such as at least 90% sequence identity, such as at least 91% sequence identity, such as at least 92% sequence identity, such as at least 93% sequence identity such as at least 94% sequence identity, such as at least 95% sequence identity, such as at least 96% sequence identity, such as at least 97% sequence identity, such as at least 98% sequence identity, such as at least 99% sequence identity, such as 100% sequence identity to SEQ ID NO: 7. In some embodiments, the first enzyme solution comprises a carbohydrase wherein the carbohydrase is a pectate lyase obtainable from Bacillus subtilis, having at least 80% sequence identity to SEQ ID NO: 7.

In some embodiments, the first enzyme solution comprises one or more carbohydrase selected from the group consisting of a polypeptide having at least 80% sequence identity to SEQ ID NO: 1, 2, 3, 4, 5, 6, or 7, such as at least 85% sequence identity, such as at least 90% sequence identity, such as at least 91% sequence identity, such as at least 92% sequence identity, such as at least 93% sequence identity such as at least 94% sequence identity, such as at least 95% sequence identity, such as at least 96% sequence identity, such as at least 97% sequence identity, such as at least 98% sequence identity, such as at least 99% sequence identity, such as 100% sequence identity to SEQ ID NO: 1, 2, 3, 4, 5, 6, or 7.

In some embodiments, the first enzyme solution comprises one or more carbohydrase selected from the group consisting of a polypeptide having at least 80% sequence identity to SEQ ID NO: 1, 2, or 3, such as at least 85% sequence identity, such as at least 90% sequence identity, such as at least 91% sequence identity, such as at least 92% sequence identity, such as at least 93% sequence identity such as at least 94% sequence identity, such as at least 95% sequence identity, such as at least 96% sequence identity, such as at least 97% sequence identity, such as at least 98% sequence identity, such as at least 99% sequence identity, such as 100% sequence identity to SEQ ID NO: 1, 2, or 3.

In some embodiments, the first enzyme solution comprises two or more carbohydrases selected from the group consisting of a polypeptide having at least 80% sequence identity to SEQ ID NO: 1, 2 or 3, such as at least 85% sequence identity, such as at least 90% sequence identity, such as at least 91% sequence identity, such as at least 92% sequence identity, such as at least 93% sequence identity such as at least 94% sequence identity, such as at least 95% sequence identity, such as at least 96% sequence identity, such as at least 97% sequence identity, such as at least 98% sequence identity, such as at least 99% sequence identity, such as 100% sequence identity to SEQ ID NO: 1, 2 or 3.

In some embodiments, the first enzyme solution comprises at least three carbohydrases having at least 80% sequence identity to SEQ ID NO: 1, 2 or 3, such as at least 85% sequence identity, such as at least 90% sequence identity, such as at least 91% sequence identity, such as at least 92% sequence identity, such as at least 93% sequence identity such as at least 94% sequence identity, such as at least 95% sequence identity, such as at least 96% sequence identity, such as at least 97% sequence identity, such as at least 98% sequence identity, such as at least 99% sequence identity, such as 100% sequence identity to SEQ ID NO: 1, 2, or 3.

The method of the disclosed technology further comprises a second enzyme solution comprising a polypeptide having protease activity is contacted with a membrane.

In some embodiments, the second enzyme solution comprises a polypeptide having protease activity selected from the group consisting of SEQ ID NO: 8, SEQ ID NO: 9, SEQ ID NO: 10, SEQ ID NO: 11, and SEQ ID NO: 12. In a preferred embodiment, the second enzyme solution comprises a polypeptide having protease activity selected from SEQ ID NO: 8 and SEQ ID NO: 11.

In some embodiments, the second enzyme solution comprises a polypeptide having protease activity. Typically, the polypeptide having protease activity is a serine protease or an aminopeptidase, such as a 51 or S8 serine protease (EC number 3.4.21.62 or a leucine aminopeptidase EC number 3.4.11).

In some embodiments, the second enzyme solution comprises a protease which may be a mono-component or multi-component enzyme mix comprising at least one polypeptide having protease activity. In some embodiments, the multi-component enzyme mix comprises one or more serine proteases and/or one or more aminopeptidases. For example, in some embodiments, the multi-component enzyme mix may comprise two or more 51 proteases, two or more S8 proteases, an 51 protease and an S8 protease, an 51 protease and an aminopeptidase, S8 protease and an aminopeptidase, or two or more aminopeptidases.

In some embodiments, the second enzyme solution comprises a protease having at least 80% sequence identity to SEQ ID NO: 8, 9, 10, 11, or 12, such as at least 85% sequence identity, such as at least 90% sequence identity, such as at least 91% sequence identity, such as at least 92% sequence identity, such as at least 93% sequence identity such as at least 94% sequence identity, such as at least 95% sequence identity, such as at least 96% sequence identity, such as at least 97% sequence identity, such as at least 98% sequence identity, such as at least 99% sequence identity, such as 100% sequence identity to SEQ ID NO: 8, 9, 10, 11, or 12.

In some embodiments, the second enzyme solution comprises a protease having at least 80% sequence identity to SEQ ID NO: 8, 10, 11, or 12, such as at least 85% sequence identity, such as at least 90% sequence identity, such as at least 91% sequence identity, such as at least 92% sequence identity, such as at least 93% sequence identity such as at least 94% sequence identity, such as at least 95% sequence identity, such as at least 96% sequence identity, such as at least 97% sequence identity, such as at least 98% sequence identity, such as at least 99% sequence identity, such as 100% sequence identity to SEQ ID NO: 8, 9, 10, 11, or 12.

In some embodiments, the second enzyme solution comprises a protease wherein the protease is a serine protease having at least 80% sequence identity to SEQ ID NO: 8, such as at least 85% sequence identity, such as at least 90% sequence identity, such as at least 91% sequence identity, such as at least 92% sequence identity, such as at least 93% sequence identity such as at least 94% sequence identity, such as at least 95% sequence identity, such as at least 96% sequence identity, such as at least 97% sequence identity, such as at least 98% sequence identity, such as at least 99% sequence identity, such as 100% sequence identity to SEQ ID NO: 8. In some embodiments, the second enzyme solution comprises a protease wherein the protease is a serine protease obtainable from Nocardiopsis sp. having at least 80% sequence identity to SEQ ID NO: 8.

In some embodiments, the second enzyme solution comprises a protease wherein the protease is an aminopeptidase having at least 80% sequence identity to SEQ ID NO: 9, such as at least 85% sequence identity, such as at least 90% sequence identity, such as at least 91% sequence identity, such as at least 92% sequence identity, such as at least 93% sequence identity such as at least 94% sequence identity, such as at least 95% sequence identity, such as at least 96% sequence identity, such as at least 97% sequence identity, such as at least 98% sequence identity, such as at least 99% sequence identity, such as 100% sequence identity to SEQ ID NO: 9. In some embodiments, the second enzyme solution comprises a protease wherein the protease is a leucine aminopeptidase obtainable from Aspergillus oryzae having at least 80% sequence identity to SEQ ID NO: 9.

In some embodiments, the second enzyme solution comprises a protease wherein the protease is an serine protease having at least 80% sequence identity to SEQ ID NO: 10, such as at least 85% sequence identity, such as at least 90% sequence identity, such as at least 91% sequence identity, such as at least 92% sequence identity, such as at least 93% sequence identity such as at least 94% sequence identity, such as at least 95% sequence identity, such as at least 96% sequence identity, such as at least 97% sequence identity, such as at least 98% sequence identity, such as at least 99% sequence identity, such as 100% sequence identity to SEQ ID NO: 10. In some embodiments, the second enzyme solution comprises a protease wherein the protease is a serine endoprotease obtainable from Alkalihalobacillus clausii. having at least 80% sequence identity to SEQ ID NO: 10.

In some embodiments, the second enzyme solution comprises a protease wherein the protease is an serine protease having at least 80% sequence identity to SEQ ID NO: 11, such as at least 85% sequence identity, such as at least 90% sequence identity, such as at least 91% sequence identity, such as at least 92% sequence identity, such as at least 93% sequence identity such as at least 94% sequence identity, such as at least 95% sequence identity, such as at least 96% sequence identity, such as at least 97% sequence identity, such as at least 98% sequence identity, such as at least 99% sequence identity, such as 100% sequence identity to SEQ ID NO: 11. In some embodiments, the second enzyme solution comprises a protease wherein the protease is a serine endoprotease obtainable from Bacillus lentus having at least 80% sequence identity to SEQ ID NO: 11.

In some embodiments, the second enzyme solution comprises a protease wherein the protease is an serine protease having at least 80% sequence identity to SEQ ID NO: 12, such as at least 85% sequence identity, such as at least 90% sequence identity, such as at least 91% sequence identity, such as at least 92% sequence identity, such as at least 93% sequence identity such as at least 94% sequence identity, such as at least 95% sequence identity, such as at least 96% sequence identity, such as at least 97% sequence identity, such as at least 98% sequence identity, such as at least 99% sequence identity, such as 100% sequence identity to SEQ ID NO: 12. In some embodiments, the second enzyme solution comprises a protease wherein the protease is a serine endoprotease obtainable from Alkalihalobacillus clausii. having at least 80% sequence identity to SEQ ID NO: 12.

In yet another aspect of the disclosed technology, the method further comprises an acidic cleaning step performed prior to the alkaline cleaning step. In such embodiments, the first enzyme solution is added to the acidic cleaning step, and the second enzyme solution is added to the alkaline cleaning step.

In some embodiments, the acidic cleaning step is performed at a pH of about 2 to about 6, and in other embodiments, the acidic cleaning step is performed at a pH of about 3 to 6. In some embodiments, the alkaline cleaning step is performed at a pH of about 8 to about 11, and in other embodiments, the alkaline cleaning step is performed at a pH of about 8 to 10.

In some embodiments, the acidic cleaning step of the present technology comprises: (a) contacting a membrane with a cleaning agent; (b) contacting the membrane with a buffer at pH 2 to 6; and (c) contacting the membrane with a first enzyme solution. In some embodiments, the membrane comprises a reverse osmosis (RO), nanofiltration (NF), or ultra-filtration (UF) membrane.

In such embodiments, the cleaning agent in the acidic cleaning step comprises a chemical surfactant. In some embodiments, the chemical surfactant comprises a non-ionic or an ionic surfactant. In such embodiments, the non-ionic surfactant comprises an alcohol ethoxylated surfactant such as, but not limited to, alcohol alkoxylates, amine oxide, alkaneamide, phosphate esters, ethoxylates alcohols and ethoxylated propoxylated alcohols. In such embodiments, the ionic surfactant comprises a sulfonated surfactant such as, but not limited to, alkyl sulfonate, alkylbenzene sulfonates, alkylbenzene sulfonic acids, alkyldiphenyl-oxide disulfonate salts, phosphate esters, alkyl ether sulfates, alkyl sulfates, and alkyl ether sulphosuccinates.

In some embodiments, the cleaning agent in the acidic cleaning step comprises glycolic acid, phosphonic acid, formic acid, citric acid, sulfonic acid, sulphamic acid, acetic acid, nitric acid, phosphoric acid, and/or combinations thereof.

In such embodiments, in step (a) of the acidic cleaning step about 2,500 ppm to about 30,000 ppm of the cleaning agent is provided to the membrane.

In some embodiments, alkaline cleaning step of the disclosed technology comprises: (d) contacting the membrane with a cleaning agent; (e) contacting the membrane with a buffer with a pH of about 8 to about 11; and (f) contacting the membrane with a second enzyme solution. In some embodiments, the membrane comprises a reverse osmosis (RO), nanofiltration (NF), or ultra-filtration (UF) membrane.

In some embodiments, in either the acidic cleaning step and/or the alkaline cleaning step, the cleaning agent further comprises a sequestration agent. In such embodiments, the sequestration agent comprises trisodium phosphate (TSP), tetra potassium pyrophosphate (TKPP), hexametaphosphate (HMP), Ethylenediamine-N,N′-disuccinic acid (EDDS), Ethylenediaminetetraacetic acid (EDTA), Hydroxyethylethylenediaminetriacetic acid (HEDTA), gluconic acid/gluconates, and/or combinations thereof.

In yet another aspect of the disclosed technology, a membrane cleaner composition is provided. The membrane cleaner composition comprises a surfactant; a first enzyme solution comprising a polypeptide having carbohydrase activity; a second enzyme solution comprising a polypeptide having protease activity; and a buffer having an alkaline pH.

In some embodiments, the first enzyme solution is selected from the group consisting of SEQ ID NO: 1, SEQ ID NO: 2, SEQ ID NO: 3, and SEQ ID NO: 4. In some embodiments, the second enzyme solution is selected from the group consisting of SEQ ID NO: 8, SEQ ID NO: 9, SEQ ID NO: 11, and SEQ ID NO: 12, and in some embodiments, SEQ ID NO: 8 AND SEQ ID NO: 11.

In some embodiments, the membrane cleaner composition further comprises a buffer having an acidic pH. In some embodiments, the first enzyme solution and the buffer having an alkaline pH are a mixture. In some embodiments, the first enzyme solution, the second enzyme solution and the buffer are a mixture. In some embodiments, the first enzyme solution and the buffer having an acidic pH are a mixture.

### EXAMPLES

The present technology will be further described in the following examples, which should be viewed as being illustrative and should not be construed to narrow the scope of the disclosed technology or limit the scope to any particular embodiments.

### Example A

The effects of enzymes on the release of primary amino nitrogen and reducing sugars from foulant from dirty RO-membrane surfaces were examined. In order to determine the degradation of proteins and polysaccharides foulant on RO membranes, various cleaning sequences, with enzymes added to the acid or alkaline cleaner steps, were applied to the membranes and the release of primary amino nitrogen and reduced sugars was measured. The foulant analyzed was from a fouled SUEZ AG-LF 400 RO membrane removed from a wastewater treatment application. The testing consisted of twenty commercial enzymes that were combined with Kleen MCT 515E.

Prior to testing, free foulant was collected from a fouled RO membrane. The free foulant was mixed with deionized (DI) water and stirred using a magnetic stirrer for at least 1 hour. The total solid (TS) of free foulant was then measured with a moisture analyzer.

Foulant and enzyme mixed with Kleen MCT 515E was added to DI water in 1.5 ml Eppendorf tubes to achieve a total solid content of approximately 1%-2.5% and a volume of 1 ml. All enzymes were dosed at 0.075 mg AEP/g TS with 1% Kleen MCT 515E. A control was then prepared by incubating enzymes at 95° C. for 30 minutes to create inactive enzymes. These inactive enzymes were then added to foulant to create the control. The tubes were then sealed and incubated at 80 rpm and 35° C. for approximately 3 to 4 hours. The solutions were mixed at 80 rpm.

The tubes were then removed from the shaker and centrifuged at 13000 rpm for 3 minutes. The supernatant was collected.

Primary amino nitrogen was measured with protease in a primary amino nitrogen assay (PAM-assay). Reduced sugars were measured with polysaccharide degrading enzymes in a p-Hydroxybenzoic acid hydrazide assay (PHBAH-assay).

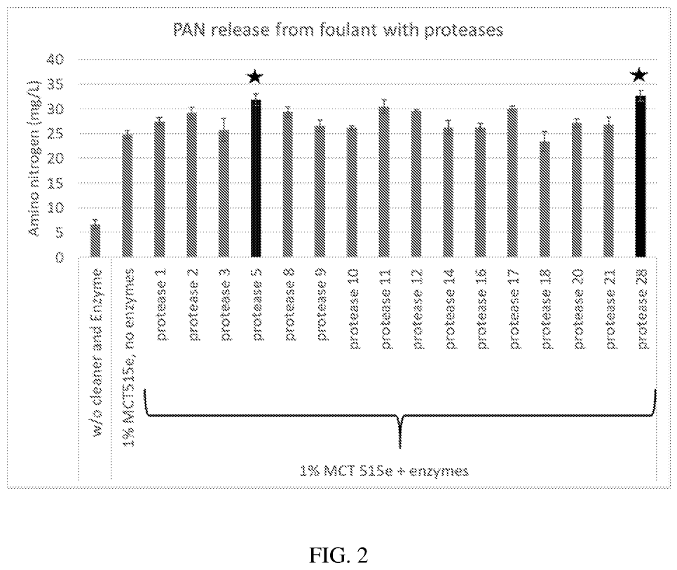

The concentration of primary amino nitrogen in the supernatant of the treated foulant is illustrated in FIG. 2, which provides the concentration of primary amino nitrogen in the supernatant of the treated foulant.

Supplementing Kleen MCT 515E with different proteases (1, 2, 5, 8, 11, 12, 17, 20, 28) increased the release of primary amino nitrogen indicating an improved degradation of proteins in the foulant. As shown in FIG. 2, the best performance was seen with protease 28 and protease 5, which exhibited around 30% more amino nitrogen release than using chemical cleaner only.

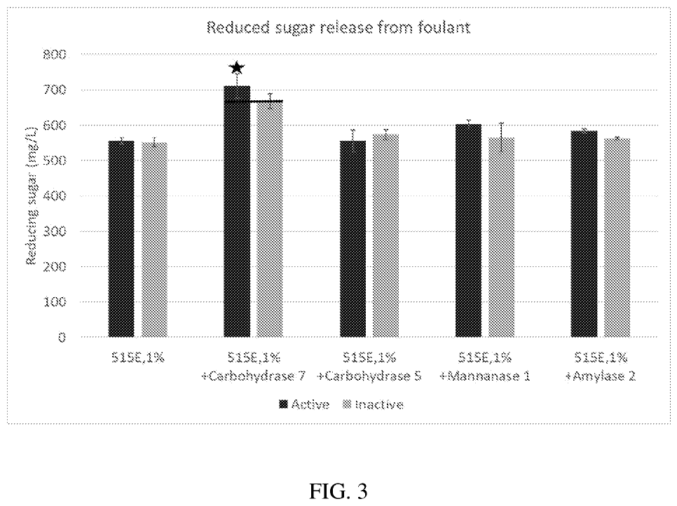

The concentration of reduced sugars in the supernatant of the treated foulant is illustrated in FIG. 3. Supplementing MCT 515E with carbohydrase 7 released more reducing sugar from the foulant than the control, which indicates an improved degradation of polysaccharides in the foulant.

### Examples B-E

The effects of enzymes on foulant release from fouled RO-membrane surfaces were also studied. Fouled RO-Membranes were cut into coupons to fit into a 24-well adapter. The coupons were gently pre-cleaned with tap water to loosen foulant floating on the surface.

The top-plate of the microtiter-plates was sealed with sealing tape to hinder evaporation of cleaning liquid during incubation.

The coupons were sandwiched between two plastic plates (3D printed, size 8.5 cm×12.5 cm). The coupons were arranged between the plates with the active site of the membrane facing upwards and secured in place. The plates were then secured with 12 screws and nuts though small holes in the top and bottom plate. The top plate contained 24 additional holes, each sealed with an O-ring, which provided exposure of the active site to cleaner solutions and enzymes.

The sealing tape was punctured to enable delivery of cleaning solution to each well. The active site was then exposed to 600 μl of various cleaning solutions. The release of foulant from the membrane to the solution following a cleaning cycle was recorded. The foulant release was measured as an increase in absorbance of the cleaning solution after a cleaning cycle.

Sealing tape was used to cover the holes made from delivering the cleaning solution to each well. The plates were incubated on thermomixers for 16 hours at 300 rpm and 35° C. Samples of the control liquids were prepared in the same manner and incubated at the same conditions.

Following incubation, 200 μl cleaning solution was withdrawn from the wells and the absorbance (or OD) was measured. The wavelengths measured were 310 nm, 320 nm, and 440 nm. The control samples were measured at the same wavelengths to detect background absorbance.

### I. Example B

In Example B, the enzymes were screened at neutral conditions for further testing. Initially, 58 enzymes were screened at neutral conditions in the procedure previously described to identify candidates for further testing with mix of cleaner solution and enzymes. The enzyme activities included several proteases, lipases, amylase, pectinases, cellulase, hemicellulases, and beta-glucanases.

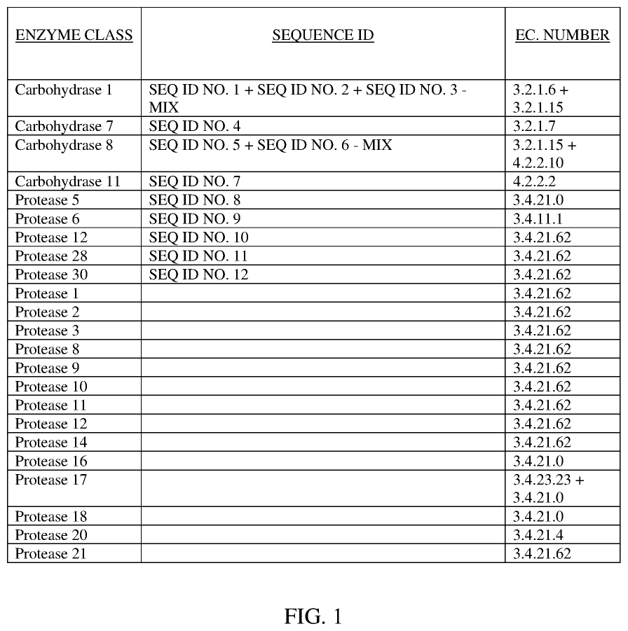

The enzymes were diluted in DI water to a concentration of 366 ppm Active Enzyme Protein. The solutions were then added to the 24 well-adapter in quadruplicate and incubated at 35° C. for 16 hours at 300 rpm. Absorbance endpoint of the enzymes solutions was measured at 310 nm and 320 nm. The nine enzymes that were selected for further testing in combination with chemical cleaners are provided in FIG. 1.

### II. Example C

In Example C, the selected individual enzymes were tested in combination with chemical cleaners. To simulate a “real-life” cleaning procedure, a two-step acid/alkaline RO membrane cleaning procedure was adapted utilizing the 3D printed 24 well-adapter previously described.

Acid step. 2% MCT103 was added to each well in the 24 well-adapter at a pH of 3.3. The well-adapter was incubated for 16 hours at 35° C. at 300 rpm in thermomixers. After incubation, all wells were gently washed with DI water to remove chemicals.

Alkaline step. 2% MCT 515E was added to control wells at a pH of 11.5. 0.5% MCT 515E was added to each test well and had pH that was adjusted to 9.1. The cleaner solution was mixed with individual enzymes at a final enzyme concentration of 22.5 ppm Active Enzyme Protein.

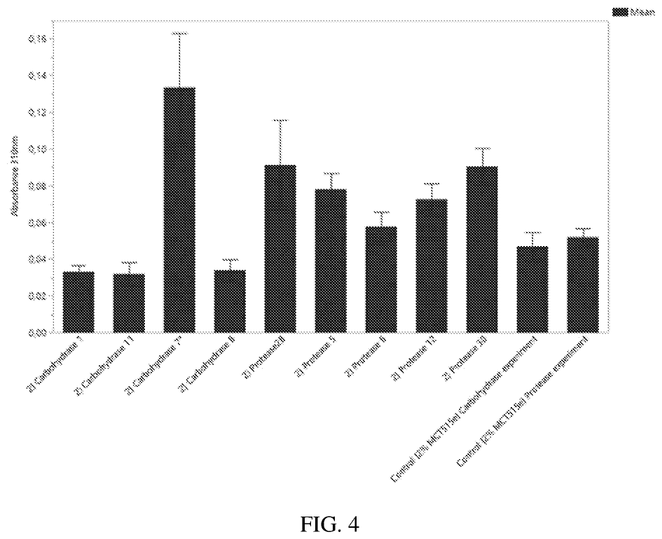

The absorbance of all wash liquids was measured after the Alkaline step and is illustrated in FIG. 4. As shown in FIG. 4, the endpoint absorbance after Alkaline step is provided, where wach error bar is constructed using 1 standard deviation from the mean. All tests with proteases had higher absorbance compared to control tests, which indicated an improved foulant release and a clear cleaning efficiency of these enzymes. Carbohydrase 7 also showed an improved foulant release, whereas carbohydrase 1, 8 and 11 were lower than the control. The lower absorbance of the latter enzymes is a result of the low cleaner concentration and lower pH compared to the other samples analyzed.

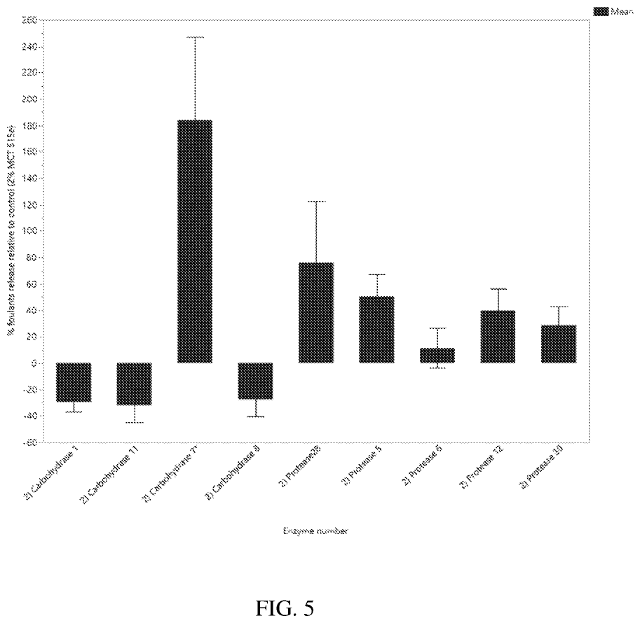

The estimated relative foulant released by the various mild enzyme wash-liquids as compared to the control wells with 2% MCT515E is shown in FIG. 5. These numbers correspond to the relative difference in absorbance after incubation between test wells and control wells. FIG. 5 shows the foulants released after individual enzymes added in Alkaline step relative to control wells (Step 1: Acid step MCT 103, 2%, Step 2: Alkaline step MCT 515E, 0.5% (pH 9.1)+enzyme). (Each error bar is constructed using 1 standard deviation from the mean.)

### III. Example D

In Example D, carbohydrases were added in the Acidic step, and proteases were added to the Alkaline step.

Acid Step. 2% MCT103 with pH adjusted to 4 was added to each well in the 24 well-adapter followed by the addition of carbohydrase enzymes. The well-adapter was incubated for 16 hours at 35° C. at 300 rpm in thermomixers. After incubation, all wells were gently washed with DI water to remove chemicals.

Alkaline Step. 0.5% MCT 515E at pH 9.1 was added to each well in the well-adapter followed by addition of protease enzymes.

The enzyme concentration in each treatment step was 22.5 ppm Active Enzyme Protein. A total number of 15 enzyme combinations were tested (three carbohydrases×five proteases). To prepare the control, for the acid step, 2% MCT103 at pH 3.3 was added to the acid control well, and for the alkaline, 2% MCT515E at pH 11.5 was added to the alkaline well.

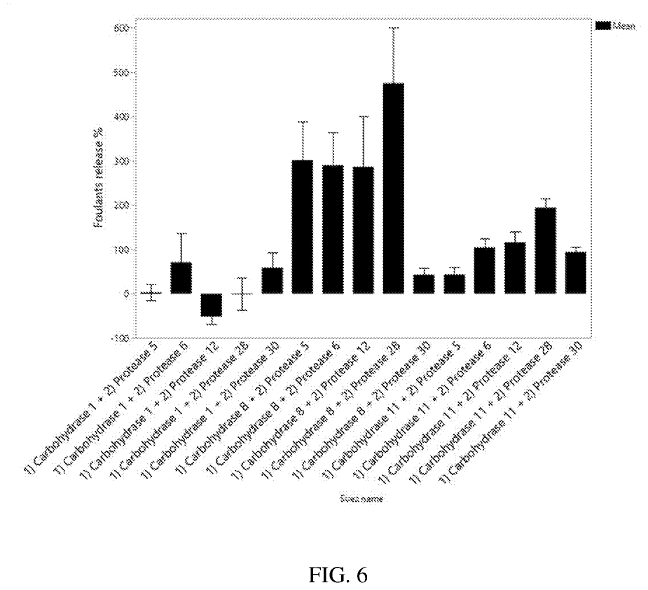

The relative foulant release by the various mild enzyme wash-liquids as compared to the control wells with just 2% MCT515E is shown in FIG. 6, which provides for the amount of foulants released after a blend of carbohydrase added in acid step and protease in alkaline step. (Each error bar is constructed using 1 standard deviation from the mean.)

These numbers correspond to the relative difference in absorbance after incubation between test wells and control wells. The data indicates that the use of various mild cleaning combinations of carbohydrases and proteases significantly improved the foulant release of the membranes. In particular, carbohydrase 8 combined with various proteases showed significant increased foulant releases of around 300% to 450% when combined with protease 5, 6, 12, or 28 when compared to the control tests.

### IV. Example E

In Example E, carbohydrases and proteases were blended and added to the Alkaline step.

Acid step. 2% MCT103 was added to each well in the 24 well-adapter at a pH of 3.3. The well-adapter was incubated for 16 hours at 35° C. at 300 rpm in thermomixers. After incubation, all wells were gently washed with DI water to remove chemicals.

Alkaline step. 0.5% MCT 515E at pH 9.1 was added to the well-adapter with blends of carbohydrases and proteases. The enzyme concentration in each treatment step was 22.5 ppm Active Enzyme Protein. A total number of 20 enzyme combinations were tested with an even 1:1 distribution based on active enzyme protein (AEP), with the exception that Carbohydrase 7 consisted of 10% of the total AEP (blended with 90% protease). The control procedure as described in Example B was followed with acid step containing 2% MCT103 at pH 3.3 and alkaline step 2% MCT515E at pH 11.5.

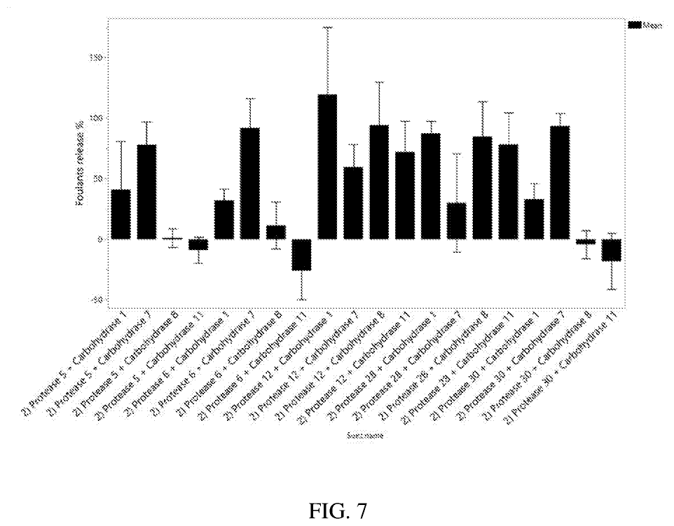

The relative foulant released by the various mild enzyme wash-liquids as compared to the control wells with 2% MCT515E is shown in FIG. 7, which provide the foulants released after a blend of protease and carbohydrase in alkaline step. (Each error bar is constructed using 1 standard deviation from the mean.) These numbers correspond to the relative difference in absorbance after incubation between test wells and control wells.

Similar to Example 3, that data shows that using various mild cleaning combinations of carbohydrases and proteases significantly improved the foulant release of the membranes when compared to the control tests. In particular, carbohydrase 7 and carbohydrase 1 showed good results and gave improved foulant release in combination with all proteases.

Cleaning Study #1

Prior to testing, the membrane coupons were cut into the desired size, sealed, and kept refrigerated (˜8° C.). A pre-clean test was conducted to test the fouled membrane coupons according to the Standard Membrane Performance Test conditions described below. The membrane coupons selected exhibited a similar performance (i.e. similar A-value and passage) to be used for further cleaning study.

A required concentration of cleaner solution was prepared using RO water in a bottle. After the cleaner was completely dissolved and the required pH was adjusted, the membrane samples were put in the bottle (e.g. 1 membrane coupon per bottle). The solution pH was then recorded.

All conditions were run in triplicate to capture the variation. The bottles were kept in a hot water shaker for approximately 16 hours at 35° C. After the desired cleaning time, the bottles were removed from the shaker and the pH of the cleaner solution was measured again. The membrane samples were then removed from the solution and rinsed with RO water approximately 3 times for ˜1 minute.

Subsequently, the cleaned samples were then tested in accordance with the Standard Membrane Performance Test Conditions, which include the following: 2000 ppm Sodium Chloride solution; 25° C.+225 psi+3 Lts/min concentrate flow; Flush time: ˜60 minutes; Permeate collected for 10 minutes; and Measure permeate weight collected in ˜10 minutes and permeate conductivity.

A-value. The passage was calculated based on the data collected from above test. The term “A-value” represents the water permeability of a membrane and is represented by the cubic-centimeters of permeate water collected per-square centimeters of membrane area times the number of seconds at the pressure measured in atmospheres. An A-value of 1 represents a cm 3 of permeate over the multiplicand of 1 centimeter squared of membrane area times 1 second of performance at a net driving pressure of one atmosphere. The A-value as given herein has the following unit designation: cm/(sec*atm) at 25° C.

Salt passage. The salt passage is a percentage that describes the amount of solute passed through RO membrane, where the passage is given by CP/Cₐᵥₑ*100% (i.e. permeate concentration (CP), feed concentration (Cf), Concentrate concentration (Cc), where Cₐᵥₑ is the average feed concentration, which is calculated as follows: Cₐᵥₑ=(Cf+Cc)/2).

A fouled membrane was removed from a wastewater treatment plant RO system and submitted for an autopsy to confirm—that it was mainly bio-fouled. Coupons were cut from the membrane for cleaner tests. Coupons having similar baseline performance were selected to ensure a common basis for the comparison of all cleaning trials.

With reference to Table 1, the details of the Cleaning Study #1 are provided below. Effective enzyme combinations as listed in Table 1 were evaluated by the cleaning protocol described above.

TABLE 1

| | Step-1 | | | | Step-2 | | | |
|---|---|---|---|---|---|---|---|---|
| | products | Temp | pH | hr | products | Temp | pH | hr |
| control | 2% Kleen MCT103 | 35 | 3.3 | 16 | 2% Kleen MCT515E | 35 | 11.5 | 16 |
| C1 | 2% Kleen MCT103 + | 35 | 4 | 16 | 0.5% Kleen MCT515E + | 35 | 9.1 | 16 |
| | 900 ppm Carbohydrase 8 | | | | 500 ppm protease28 | | | |
| C2 | 2% Kleen MCT103 | 35 | 3.3 | 16 | 0.5% Kleen MCT515E + | 35 | 9.1 | 16 |
| | | | | | 250 ppm protease 12 + | | | |
| | | | | | 162 ppm carbohydrase 1 | | | |
| C3 | 2% Kleen MCT103 | 35 | 3.3 | 16 | 0.5% Kleen MCT515E + | 35 | 9.1 | 16 |
| | | | | | 250 ppm protease28 + | | | |
| | | | | | 450 ppm carbohydrase 8 | | | |
| C4 | 2% Kleen MCT103 | 35 | 3.3 | 16 | 0.5% Kleen MCT515E + | 35 | 9.1 | 16 |
| | | | | | 250 ppm protease28 + | | | |
| | | | | | 162 ppm carbohydrase 1 | | | |
| C5 | 2% Kleen MCT103 + | 35 | 4 | 16 | 0.5% Kleen MCT515E + | 35 | 9.1 | 16 |
| | 750 ppm Carbohydrase 7 | | | | 500 ppm protease28 | | | |
| C6 | 2% Kleen MCT103 | 35 | 3.3 | 16 | 0.5% Kleen MCT515E + | 35 | 9.1 | 16 |
| | | | | | 250 ppm protease28 + | | | |
| | | | | | 375 ppm carbohydrase 7 | | | |
| C7 | 2% Kleen MCT103 + | 35 | 4 | 16 | 0.5% Kleen MCT515E + | 35 | 9.1 | 16 |
| | 900 ppm Carbohydrase 8 | | | | 386 ppm protease5 | | | |
| C8 | 2% Kleen MCT103 + | 35 | 4 | 16 | 0.5% Kleen MCT515E + | 35 | 9.1 | 16 |
| | 900 ppm Carbohydrase 8 | | | | 265 ppm protease6 | | | |
| C9 | 2% Kleen MCT103 + | 35 | 4 | 16 | 0.5% Kleen MCT515E + | 35 | 9.1 | 16 |
| | 900 ppm Carbohydrase 8 | | | | 500 ppm protease 12 | | | |
| C10 | 2% Kleen MCT103 | 35 | 3.3 | 16 | 0.5% Kleen MCT515E + | 35 | 9.1 | 16 |
| | | | | | 210 ppm Muramidase | | | |
| C11 | 2% Kleen MCT103 | 35 | 3.3 | 16 | 0.5% Kleen MCT515E + | 35 | 9.1 | 16 |
| | | | | | 105 ppm Muramidase + | | | |
| | | | | | 250 ppm Protease28 | | | |
| C12 | 2% Kleen MCT103 | 35 | 3.3 | 16 | 0.5% Kleen MCT515E + | 35 | 9.1 | 16 |
| | | | | | 105 ppm Muramidase + | | | |
| | | | | | 250 ppm Protease 12 | | | |

The pH of the acidic cleaning solution containing a carbohydrase based enzyme was adjusted to 4 with 8% NaOH prior to the addition of the enzymes, while the pH of the alkaline cleaning solution containing any of the enzyme was adjusted to 9.1 with 10% HCl prior to the addition of specific enzymes. Following the cleaning protocol, all cleaning trials were conducted in two steps: an acid cleaning step, followed by an alkali cleaning step, wherein each cleaning step was a duration of ˜16 hours. 2% Kleen MCT103 followed by 2% Kleen MCT515E was the standard CIP process and used as a control.

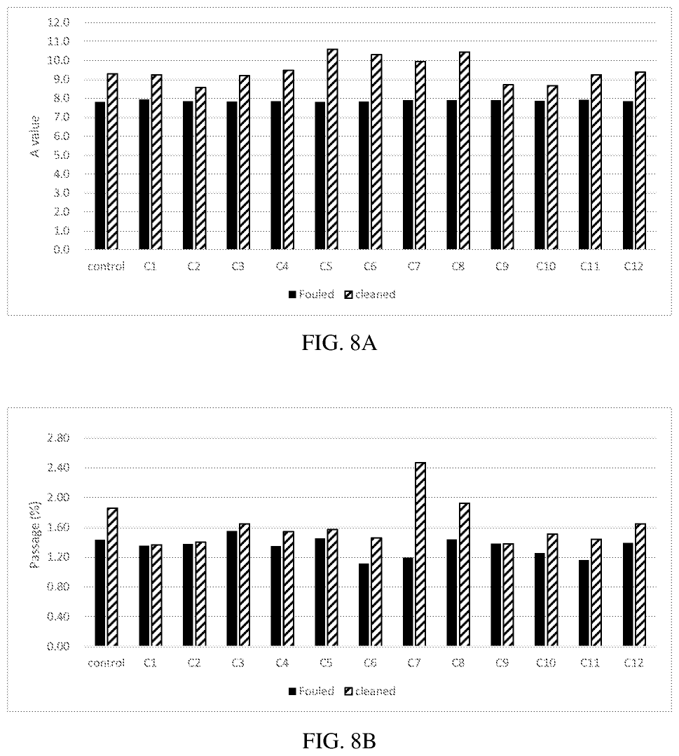

To assess the cleaning efficacy of the different enzyme combinations, fouled membranes and cleaned membranes were tested, the results which are summarized as shown in Table 2 (and in FIGS. 8A-8B).

TABLE 2

| | |
|---|---|
| A value | Passage (%) |

| | Fouled | cleaned | | Fouled | cleaned |
|---|---|---|---|---|---|
| control | 7.8 | 9.3 | control | 1.4 | 1.9 |
| C1 | 7.9 | 9.2 | C1 | 1.4 | 1.4 |
| C2 | 7.8 | 8.6 | C2 | 1.4 | 1.4 |
| C3 | 7.8 | 9.2 | C3 | 1.5 | 1.6 |
| C4 | 7.8 | 9.5 | C4 | 1.3 | 1.5 |
| C5 | 7.8 | 10.6 | C5 | 1.5 | 1.6 |
| C6 | 7.8 | 10.3 | C6 | 1.1 | 1.5 |
| C7 | 7.9 | 9.9 | C7 | 1.2 | 2.5 |
| C8 | 7.9 | 10.4 | C8 | 1.4 | 1.9 |
| C9 | 7.9 | 8.7 | C9 | 1.4 | 1.4 |
| C10 | 7.9 | 8.7 | C10 | 1.3 | 1.5 |
| C11 | 7.9 | 9.2 | C11 | 1.2 | 1.4 |
| C12 | 7.8 | 9.4 | C12 | 1.4 | 1.6 |

With reference to Table 2, after the two-step cleaning, all the cleaning trials showed improved performance C5, C6, C7 and C8 showed higher A-values of a cleaned membrane than that of a control, which strongly demonstrates that better cleaning efficacy in membrane permeability recovery is achieved with the help of particular enzyme combinations. A higher passage was observed for all the cleaning trials, which is believed to be due to unveiled defects after the membrane foulant was removed. In addition, C5, C6, C7, and C8 outperformed C10, C11, and C12 in terms of A-value recovery, thus suggesting that the combination of carbohydrase 7 and protease 28, carbohydrase 8 and protease 5 are preferable to other combinations, e.g. muramidase+protease in membrane cleaning enhancement.

Cleaning Study #2

Since it is very challenging for many sites to conduct a long CIP process (e.g. 16 hours of alternative circulation and soaking) if there's an urgent water demand from their process, Cleaning Study #2 was used to test the cleaning efficacy of enzyme cleaning under a short timeframe. To better understand enzyme cleaning performance, offline cleaning with 2% cleaner product at pH of 11.5 and 0.5% cleaner product at mild pH of 9.1 (as listed in Table 3) were used as control experiments.

TABLE 3

| | Step-1 | | | | Step-2 | | | |
|---|---|---|---|---|---|---|---|---|
| | products | Temp | pH | hr | products | Temp | pH | hr |
| C13 | 2% Kleen | 35 | 3.3 | 2 | 0.5% Kleen | 35 | 9.1 | 2 |
| | MCT103 | | | | MCT515 + 375 ppm | | | |
| | | | | | carbohydrase 7 + 500 ppm | | | |
| | | | | | protease28 | | | |
| Ctrl- | 2% Kleen | 35 | 3.3 | 2 | 2% Kleen MCT515 | 35 | 11.5 | 2 |
| 1 | MCT103 | | | | | | | |
| Ctrl- | 2% Kleen | 35 | 3.3 | 2 | 0.5% Kleen MCT515 | 35 | 9.1 | 2 |
| 2 | MCT103 | | | | | | | |

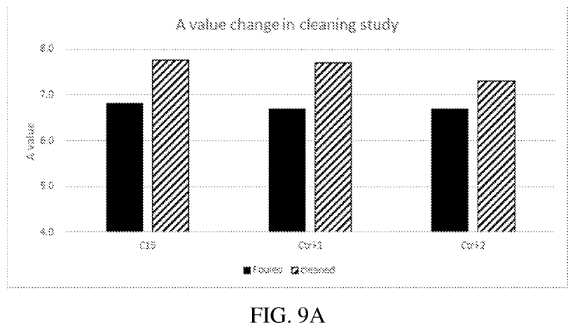

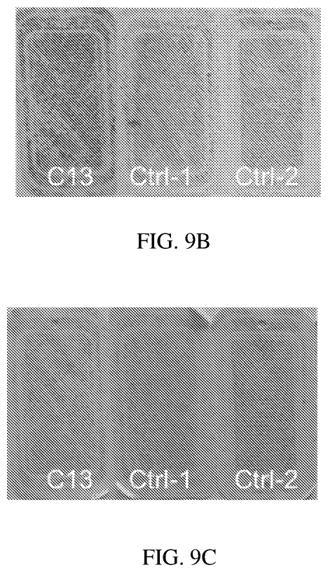

To assess the cleaning efficacy, fouled membranes and cleaned membranes were tested, the results which are summarized as shown in Table 4 (as well as shown in FIGS. 9A-9C).

TABLE 4

| | |
|---|---|
| A value | Passage (%) |

| | Fouled | cleaned | | Fouled | cleaned |
|---|---|---|---|---|---|
| C13 | 6.8 | 7.8 | C13 | 2.4 | 2.5 |
| Ctrl-1 | 6.7 | 7.7 | Ctrl-1 | 1.3 | 1.5 |
| Ctrl-2 | 6.7 | 7.3 | Ctrl-2 | 1.2 | 1.7 |

After two-step cleaning, C13 showed the comparable performance to Ctrl-1, which demonstrated enzyme cleaning at mild pH of 9.1 can achieve performance similar to the standard cleaning at high pH of 11.5. C13 outperformed Ctrl-2 at the same cleaner product dosage and pH, demonstrating that the addition of enzymes can benefit cleaning efficacy at mild conditions.

In addition to the membrane performance comparison, the visual appearance of membrane coupons before and after cleaning were captured, as shown in FIG. 9B and FIG. 9C. After cleaning, C13 in FIG. 9C showed less foulant than Ctrl-1 and Ctrl-2. The cleaner surface translates into lower pressure drop on site. Therefore, a moderate pressure drop improvement with C13 can be expected.

Additionally, more surface foulant leftover after cleaning may require more frequent CIP's or a shorter CIP interval to maintain the system's productivity. However, harsh chemical contact during CIP process may be detrimental to membrane materials, which may lead to membrane performance loss in the long term. In other words, enzyme cleaning gives a cleaner membrane surface and provides a benefit to membrane life.

Cleaning Study #3

It should be noted that Clean-In-Place (CIP) of RO membranes should be carried out immediately if key normalized parameters change. For example, if (i) normalized flow declines by 10%, (ii) normalized dP, increases by 15%; or (iii) normalized salt passage increases by 5%. Otherwise, irreversible damage to the membrane may occur.

To initiate a CIP, the following steps were undertaken: (1) Fill up CIP tank with RO water; (2) Start recirculation, open the discharge, flush the system and check/fix the leakage (if any). All chemical usage is based on the total CIP volume of 3500 liters; (3) Dissolve the membrane cleaner products (i.e. first chemical) into demineralized water to prepare a designed cleaning solution, allowing it to recirculate for at least 10 mins to reach homogenization, and then measuring pH value and conductivity; (4) Adjust the pH to the target value using HCl or NaOH accordingly, prior to the addition of enzymes (i.e. second chemicals); (5) Start the recirculation for 16 hours, recording the pressure and temperature every two hours; and (6) Stop the CIP process and discharge the CIP solution according to the local regulation, thoroughly flush the system with demineralized water and then get the system back to operation.

The clean-in-place (CIP) trials were carried out on different production lines for membranes from an Industrial Reverse Osmosis application. The details of the CIP trials are listed in Table 5 below. Each production line was configured in a two-stage array of 5:3 RO vessels with six spiral-wound membrane elements per vessel. The RO units used were AG8040E-400 membrane elements (SUEZ WTS) in all two stages.

TABLE 5

| | Step-1 | PH | Step-2 | PH |
|---|---|---|---|---|
| G1 | 2% Kleen MCT103 | 3.3 | 2% Kleen MCT515E | 11.5 |
| G2 | 2% Kleen MCT103 | 3.3 | 2% Kleen MCT515E + 375 ppm | 9.1 |
| | | | carbohydrase 7 + 500 ppm | |
| | | | protease28 | |
| G3 | 2% Kleen | 4 | 2% Kleen MCT515E + 386 ppm | 9.1 |
| | MCT103 + 900 ppm | | protease 5 | |
| | Carbohydrase 8 | | | |
| G4 | 2% Kleen MC400 | 2.8 | 1.5% Kleen MCT411 | 10.6 |

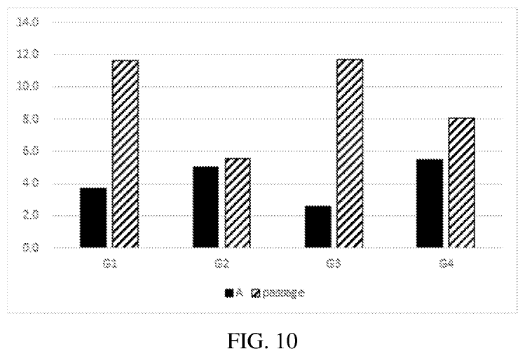

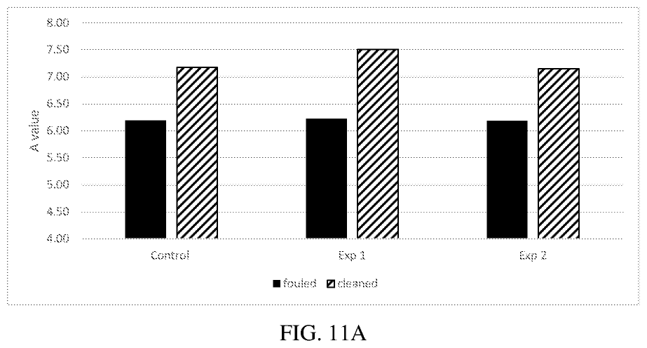

After the cleanings were conducted, coupons were cut from the cleaned RO elements and performance testing (Flux and Passage) was conducted. With reference to FIG. 10 G2 (which utilizes a combination of a protease and carbohydrase in the alkaline cleaner step) exhibited improved results versus the baseline established by the same cleaners without enzymes G1, and approached the performance of the oxidizer cleaner G4. Higher passage was observed in cleaning trial G3, which is believed to be due to the defects present in the membrane used. Additionally, the average A-value and passage of 12 coupons are listed in Table 6. From the comparison, it was exhibited that the addition of the enzymes to the alkaline cleaning step clearly demonstrated an improvement on cleaning efficacy.

TABLE 6

| | A | Passage |
|---|---|---|
| G1 | 3.7 | 11.64 |
| G2 | 5.0 | 5.56 |
| G3 | 2.6 | 11.71 |
| G4 | 5.5 | 8.08 |

Cleaning Study #4

In Cleaning Study #4, SUEZ WTS AGLF400 fouled membrane elements were removed from a wastewater treatment plant to be tested.

A baseline performance test was conducted according to the following: (1) Load the fouled membrane element into a single element vessel; (2) Fill up the CIP tank with tap water, open the vents and start to flush the system for ˜10 min, fix the leakage (if any); (3) Prepare 2000 ppm NaCl solution with tap water, all the chemical usage is based on the total CIP on the total CIP volume of 250 liters; (4) Start the recirculation for ˜5 min to get homogenization, gradually increase the feed pressure to −10 bar, maintain the system temperature at 30° C. with the help of a chiller; (5) Measure the temperature, permeate flow rate, system pressure and conductivity after ˜15 min of operation as baseline performance of fouled membrane; (6) Stop the system, open the concentrate valve; and (7) Discharge the salt solution and flush the system with tap water until the concentrate conductivity is comparable to that of tap water.

Subsequently, a membrane CIP was conducted according to the following: (1) Dissolve the cleaner product (i.e. first chemical) into tap water to prepare a designed cleaning solution, allow it to recirculate for at least 10 mins to reach homogenization, and then measure pH value and conductivity; (2) Adjust the pH to the target value accordingly using HCl or NaOH prior to the addition of enzymes (i.e. second chemicals); (3) Start the recirculation at 35° C. for ˜16 hours; and (4) Stop the CIP process and discharge the CIP solution according to the local regulation, and thoroughly flush the system with tap water at −3 bars for ˜30 min until the conductivity of concentrate and feed are the same. Thereafter, a cleaned membrane performance test was conducted, which included a re-check of the membrane element performance as cleaned membrane performance by using the same protocol described in baseline performance test described above.

The clean-in-place (CIP) trials were carried out on a single element RO skid and the details of CIP trials are listed in Table 7. The RO units were AG LF-400 membrane elements (SUEZ WTS) sent from a wastewater treatment plant, in which the membrane was mainly fouled by biological materials that were confirmed by the membrane autopsy.

TABLE 7

| | Step 1 | | | | Step 2 | | | |
|---|---|---|---|---|---|---|---|---|
| | Kleen MCT103 | pH | Enzyme | Incubation | Kleen MCT515 | pH | Enzyme | Incubation |
| Control | 2% | no adjustment | no | 16 h/35 C. | 2% | no adjustment | no | 16 h/35 C. |
| Exp 1 | 2% | no adjustment | no | 16 h/35 C. | 0.5% | 9.1 | 375 ppm | 16 h/35 C. |
| | | | | | | | carbohydrase | |
| | | | | | | | 7 + 500 ppm | |
| | | | | | | | protease28 | |
| Exp 2 | 2% | 4 | 900 ppm | 16 h/35 C. | 0.5% | 9.1 | 386 ppm | 16 h/35 C. |
| | | | Carbohydrase 8 | | | | protease5 | |

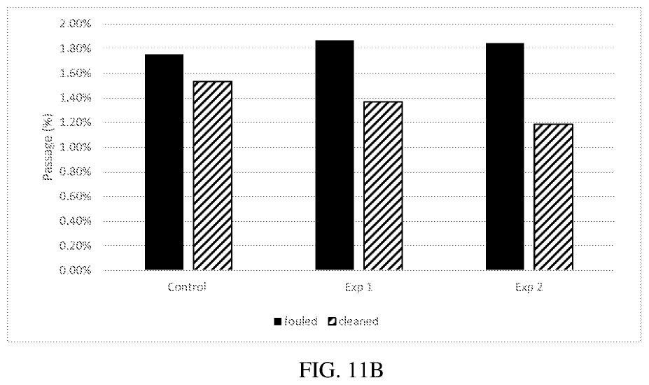

With reference to FIGS. 11A-11B, the membrane performance before and after CIP is shown. From the comparison shown in FIGS. 11A-11B, the results successfully demonstrated that a significant reduction of cleaner usage can achieve better and more comparable performance in terms of A-value or passage (as shown in Table 8 with the addition of ppm level of enzyme. Such results can be achieved either by (i) the addition of carbohydrase and protease together into the alkaline step, or (ii) the addition of the carbohydrase in the acidic step and the addition of the protease in the alkaline step.

TABLE 8

| A value | | | | Passage (%) | | | |
|---|---|---|---|---|---|---|---|
| | Control | Exp 1 | Exp 2 | | Control | Exp 1 | Exp 2 |
| fouled | 6.19 | 6.23 | 6.19 | fouled | 1.75% | 1.87% | 1.84% |
| cleaned | 7.17 | 7.51 | 7.15 | cleaned | 1.53% | 1.37% | 1.19% |

While embodiments of the disclosed technology have been described, it should be understood that the present disclosure is not so limited and modifications may be made without departing from the disclosed technology. The scope of the disclosed technology is defined by the appended claims, and all devices, processes, and methods that come within the meaning of the claims, either literally or by equivalence, are intended to be embraced therein.

1. A method for cleaning a water filtration membrane, the method comprising at least an alkaline cleaning step, wherein said method includes a first enzyme solution comprising a polypeptide having carbohydrase activity, and a second enzyme solution comprising a polypeptide having protease activity.

2. The method according to claim 1, further comprising an acidic cleaning step performed prior to said alkaline cleaning step.

3. The method according to claim 2, wherein said first enzyme solution is added to said acidic cleaning step, and said second enzyme solution is added to said alkaline cleaning step.

4. The method according to claim 2, wherein said first enzyme solution and second enzyme solutions are added to said alkaline cleaning step.

5. The method according to claim 2, wherein the membrane is contacted with about 50 ppm to about 2000 ppm of said second enzyme solution.

6. The method according to claim 2, wherein said acidic cleaning step is performed at a pH of about 2 to about 6, such as from about 3 to 6.

7. The method according to claim 1, wherein said alkaline cleaning step is performed at a pH of about 8 to about 11, such as from about 8 to 10.

8. The method according to claim 1, wherein said first enzyme solution comprises one or more enzyme selected from the group consisting of SEQ ID NO: 1, SEQ ID NO: 2, SEQ ID NO: 3, SEQ ID NO: 4, SEQ ID NO: 5, SEQ ID NO: 6, and SEQ ID NO: 7.

9. The method according to claim 8, wherein said first enzyme solution comprises one or more enzyme selected from the group consisting of SEQ ID NO: 1, SEQ ID NO: 2, SEQ ID NO: 3, and SEQ ID NO: 4.

10. The method according to claim 1, wherein said second enzyme solution is selected from the group consisting of SEQ ID NO: 8, SEQ ID NO: 9, SEQ ID NO: 10, SEQ ID NO: 11, and SEQ ID NO: 12.

11. The method according to claim 3, wherein said acidic cleaning step comprises:
a. contacting said membrane with a cleaning agent;
b. contacting said membrane with a buffer at pH 2 to 6; and
c. contacting said membrane with said first enzyme solution.

12. The method according to claim 3, wherein said alkaline cleaning step comprises:
a. contacting said membrane with a cleaning agent;
b. contacting said membrane with a buffer with a pH of about 8 to about 11; and
c. contacting said membrane with said second enzyme solution.

13. The method according to claim 11 or 12, wherein said cleaning agent comprises a chemical surfactant.

14. The method according to claim 11, wherein said membrane is contacted with about 50 ppm to about 2000 ppm of said first enzyme solution.

15. The method according to claim 1, wherein said membrane comprises a RO, NF, or UF membrane.

16. The method according to claim 11, wherein said cleaning agent comprises glycolic acid, phosphonic acid, formic acid, citric acid, sulfonic acid, sulphamic acid, acetic acid, nitric acid, phosphoric acid, and/or combinations thereof.

17. The method according to claim 11, wherein in step (a) about 2,500 ppm to about 30,000 ppm of the cleaning agent is provided to the membrane.

18. The method according to claim 13, wherein said chemical surfactant comprises a non-ionic or an ionic surfactant.

19. The method according to claim 18, wherein said non-ionic surfactant comprises an alcohol ethoxylated surfactant selected from the group consisting of alcohol alkoxylates, amine oxide, alkaneamide, phosphate esters, ethoxylates alcohols and ethoxylated propoxylated alcohols.

20. The method according to claim 18, wherein said ionic surfactant comprises a sulfonated surfactant selected from the group consisting of alkyl sulfonate, alkylbenzene sulfonates, alkylbenzene sulfonic acids, alkyldiphenyl-oxide disulfonate salts, phosphate esters, alkyl ether sulfates, alkyl sulfates, and alkyl ether sulphosuccinates.

21. The method according to claim 11 or 12, wherein said cleaning agent further comprises a sequestration agent.

22. The method according to claim 21, wherein the sequestration agent comprises trisodium phosphate, tetra potassium pyrophosphate, hexametaphosphate, Ethylenediamine-N, N′-disuccinic acid, Ethylenediaminetetraacetic acid, Hydroxyethylethylenediaminetriacetic acid, gluconic acid/gluconates, and/or combinations thereof.

23. The method according to claim 1, wherein said first enzyme solution and said second enzyme solution are provided to a water filtration membrane as a mixture.

24. (canceled)

25. A membrane cleaner comprising:
i. a chemical cleaner comprising a surfactant;
ii. a first enzyme solution comprising a polypeptide having carbohydrase activity;
iii. a second enzyme solution comprising a polypeptide having protease activity; and
iv. a buffer having an alkaline pH.

26. (canceled)

27. (canceled)

28. (canceled)

29. (canceled)

30. (canceled)

31. (canceled)

32. (canceled)


SEQUENCE LISTING (12 sequences)

SEQ ID NO: 1 - protein, 332 aa, Aspergillus aculeatus
  PEPTIDE (1)..(332)
MKLLNLLVAAAAAGSAVAAPTHEHTKRASVFEWIGSNESDAEFGTAIPGTWGIDYIFPDTSAIATLVSKGMNIFRVQFMMERLVPNSMTGSYDDAYLNNLTTVVNAIAAAGVHAIVDPHNYGRYNNEIISSTADFQTFWQNLAGQFKDNDLVIFDTNNEYNTMDQTLVLDLNQAAIDGIRAAGATSQYIFAEGNSWSGAWTWADINDNMKALTDPQDKLVYEMHQYLDSDGSGTSGVCVSETIGAERLQAATQWLKDNGKVDILGEYAGGANDVCRTAIAGMLEYMANNTDVWKGAVWWTAGPWWADYMFSMEPPSGPAYSGMLDVLEPYLG

SEQ ID NO: 2 - protein, 396 aa, Aspergillus aculeatus
  PEPTIDE (1)..(396)
MLLYRGLLLLLHVLLVHSAALQPRLSTATRETCQTSLKCPEGTIIVSNSSHPAAQFKSIQAAFASLPNDNSSHTILVLAGTYHEQLNLTRPGPVTLLGQQPDRSALTDPTRNRVTITWAAANQDNTGQSVDNVYSSVLIVSPTLDASLTGSGTTGFAVPADTPFGNTDFRVYNIDFRNLWAEYSDGPAHAISFSRANGGFYYSGFYSYQDTVYIGKLGNAYFHKSIIAGQTDFLYGFGTAWIQSSSILLRSCGGGITAWKGTNTTFENNYGVYIVDSTVNAANSSLVSEIKGKCALGRPWNSLHRSIFVNSYEDGSIEPSGYINWEDRWAANQTLMAEYRAYGPGFNATGRKEGGVAVLLNAQEYKRYDSLEKVFLTPEGEAGNIAWIDWDIAGKD

SEQ ID NO: 3 - protein, 378 aa, Aspergillus aculeatus
  PEPTIDE (1)..(378)
MHLNTTLLVSLALGAVSVLASPAPPAITAPPTAEEIAKRATTCTFSGSNGASSASKSKTSCSTIVLSNVAVPSGTTLDLTKLNDGTHVIFSGETTFGYEEWSGPLISVSGSDLTITGASGHSINGDGSRWWDGEGGNGGKTKPKFFAAHSLTNSVISGLKIVNSPVQVFSVASSDYLTLKDITIDNSDGDDNGGHNTDAFDIGTSTYVTITGATVYNQDDCVAVNSGENIYLSGGYCSGGHGLSIGSVGGRSDNTVKNVTFVDSTIINSDNGVRIKTNIDTTGSVSDITYKDITLTSIAKYGIVVQQNYGDTSETPTTGVPITDFVLDNVHGSVVSSGTNILISCGSGSCSDWTWTDVSVSGGKTSSKCVNLPSGISC

SEQ ID NO: 4 - protein, 516 aa, Aspergillus niger
  PEPTIDE (1)..(516)
MLNPKVAYMVWMTCLGLMLPSQAQSNDYRPSYHFTPDQYWMNEPNGLIKIGSTWHLFFQHNPTANVWGNICWGHATSTDLMHWAHKPTAIADENGVEAFTGTAYYDPNNTSGLGDSANPPYLAWFTGYTTSSQTQDQRLAFSVDNGATWTKFQGNPIISTSQEAPHDITGGLESRDPKVFFHRQSGNWIMVLAHGGQDKLSFWTSADTINWTWQSDLKSTSINGLSSDITGWEVPDMFELPVEGTEETTWVVMMTPAEGSPAGGNGVLAITGSFDGKSFTADPVDASTMWLDNGRDFDGALSWVNVPASDGRRIIAAVMNSYGSNPPTTTWKGMLSFPRTLSLKKVGTQQHFVQQPITELDTISTSLQTLANQTITPGQTLLSSIRGTALDVRVAFYPDAGSVLSLAVRKGASEQTVINYTQSDATLSVDRTESGDISYDPAAGGVHTAKLEEDGTGLVSIRVLVDTCSVEVFGGQGEAVISDLIFPSDSSDGLALEVTGGNAVLQSVDVRSVSLE

SEQ ID NO: 5 - protein, 379 aa, Aspergillus niger
  PEPTIDE (1)..(379)
MKYSTIFSAAAAVFAGSAAAVGVSGSAEGFAKGVTGGGSATPVYPDTIDELVSYLGDDEARVIVLTKTFDFTDSEGTTTGTGCAPWGTASACQVAIDQDDWCENYEPDAPSVSVEYYNAGTLGITVTSNKSLIGEGSSGAIKGKGLRIVSGAENIIIQNIAVTDINAKYVWGGDAITLDDCDLVWIDHVTTARIGRQHYVLGTSADNRVSLTNNYIDGVSDYSATCDGYHYWAIYLDGDADLVTMKGNYIYHTSGRSPKVQDNTLLHAVNNYWYDISGHAFEIGEGGYVLAEGNVFQNVDTVLETYEGEAFTVPSTTAGEVCSTYLGRDCVINGFGSSGTFSEDSTSFLSDFEGKNIASASAYTSVASSVVANAGQGNL

SEQ ID NO: 6 - protein, 338 aa, Aspergillus niger
  PEPTIDE (1)..(338)
STCTFTDAATASESKTSCSDIVLKDITVPAGETLNLKDLNDGTTVTFEGTTTWEYEEWDGPLLRISGKDITVTQSSDAVLDGNGAKWWDGEGTNGGKTKPKFFYAHDLDDSKISGLYIKNTPVQAISVESDNLVIEDVTIDNSDGDSEGGHNTDGFDISESTYITITGATVKNQDDCVAINSGENIYFSGGTCSGGHGLSIGSVGGRDDNTVKNVTFIDSTVSDSENGVRIKTVYDATGTVEDITYSNIQLSGISDYGIVIEQDYENGDPTGTPSNGVTISDVTLEDITGSVDSDAVEIYILCGDGSCSDWTMSGIDITGGETSSDCENVPSGASCDQ

SEQ ID NO: 7 - protein, 399 aa, Bacillus subtilis
  PEPTIDE (1)..(399)
ADLGHQTLESNDGWGAYSTGTTGGSKASSSHVYTVSNRNQLVSALGKPTNTTPKIIYIKGTIDFNVDDNLKPLGLNDYKDPEYDLDKYLKAYDPSTWGKKEPSGPLEEARARSQKNQKARVMVDIPANTTIVGSGTNAIIVGGNFHIKSDNVIIRNIEFQDAYDYFPQWDPTDGSSGNWNSQYDNITINGGTHIWIDHCTFNDGSRPDSTSPTYFGRPYQHHDGQTDASNGANYITMSYNYYHDHDKSSIFGSSDSKISDDGKLKITLHHNRYKNIVQRAPRVRFGQVHVYNNYYEGSTSSSDYPFSYAWGIGKSSKIYAQNNVIDVPGLPAAKTIKVFSGGTALYDSGTLLNGTQINASAANGLSSSVGWTPSLHGTIDASAHVKSNVISQAGAGKLN

SEQ ID NO: 8 - protein, 187 aa, Nocardiopsis sp.
  PEPTIDE (1)..(187)
ADIIGGLAYTMGGRCSVGFAATNAAGQPGFVTAGHCGRVGTQVTIGNGRGVFEQSVFPGNDAAFVRGTSNFTLTNLVSRYNTGGYATVAGHNQAPIGSSVCRSGSTTGWHCGTIQARGQSVSYPEGTVTNMTRTTVCAEPGDSGGSYISGTQAQGVTSGGSGNCRTGGTTFYQEVTPMVNSWGVRLR

SEQ ID NO: 9 - protein, 771 aa, Aspergillus oryzae
  PEPTIDE (1)..(771)
MKYSKLLLLLVSVVQALDVPRKPHAPTGEGSKRLTFNETVVKQAITPTSRSVQWLSGAEDGSYVYAAEDGSLTIENIVTNESRTLIPADKIPTGKEAFNYWIHPDLSSVLWASNHTKQYRHSFFADYYVQDVESLKSVPLMPDQEGDIQYAQWSPVGNTIAFVRENDLYVWDNGTVTRITDDGGPDMFHGVPDWIYEEEILGDRYALWFSPDGEYLAYLSFNETGVPTYTVQYYMDNQEIAPAYPWELKIRYPKVSQTNPTVTLSLLNIASKEVKQAPIDAFESTDLIIGEVAWLTDTHTTVAAKAFNRVQDQQKVVAVDTASNKATVISDRDGTDGWLDNLLSMKYIGPIKPSDKDAYYIDISDHSGWAHLYLFPVSGGEPIPLTKGDWEVTSILSIDQERQLVYYLSTQHHSTERHLYSVSYSTFAVTPLVDDTVAAYWSASFSANSGYYILTYGGPDVPYQELYTTNSTKPLRTITDNAKVLEQIKDYALPNITYFELPLPSGETLNVMQRLPPGFSPDKKYPILFTPYGGPGAQEVTKRWQALNFKAYVASDSELEYVTWTVDNRGTGFKGRKFRSAVTRQLGLLEAEDQIYAAQQAANIPWIDADHIGIWGWSFGGYLTSKVLEKDSGAFTLGVITAPVSDWRFYDSMYTERYMKTLSTNEEGYETSAVRKTDGFKNVEGGFLIQHGTGDDNVHFQNSAALVDLLMGDGVSPEKLHSQWFTDSDHGISYHGGGVFLYKQLARKLYQEKNRQTQVLMHQWTKKDLEE

SEQ ID NO: 10 - protein, 382 aa, Alkalihalobacillus clausii
  PEPTIDE (1)..(382)
MMRKKSFWLGMLTAFMLVFTMAFSDSASAAEEAKEKYLIGFNEQEAVSEFVEQVEANDEVAILSEEEEVEIELLHEFETIPVLSVELSPEDVDALELDPAISYIEEDAEVTTMAQSVPWGISRVQAPAAHNRGLTGSGVKVAVLDTGISTHPDLNIRGGASFVPGEPSTQDGNGHGTHVAGTIAALNNSIGVLGVAPSAELYAVKVLGASGSGSVSSIAQGLEWAGNNGMHVANLSLGSPSPSATLEQAVNSATSRGVLVVAASGNSGAGSISYPARYANAMAVGATDQNNNRASFSQYGAGLDIVAPGVNVQSTYPGSTYASLNGTSSATPHVAGAAALVKQKNPSWSNVQIRNHLKNTATSLGSTNLYGSGLVNAEAATR

SEQ ID NO: 11 - protein, 382 aa, Bacillus lentus
  PEPTIDE (1)..(382)
MMRKKSFWLGMLTAFMLVFTMAFSDSASAAEEAKEKYLIGFNEQEAVSEFVEQVEANDEVAILSEEEEVEIELLHEFETIPVLSVELSPEDVDALELDPAISYIEEDAEVTTMAQSVPWGISRVQAPAAHNRGLTGSGVKVAVLDTGISTHPDLNIRGGASFVPGEPSTQDGNGHGTHVAGTIAALNNSIGVLGVAPSAELYAVKVLGASGSGSVSSIAQGLEWAGNNGMHVANLSLGSPSPSATLEQAVNSATSRGVLVVAASGNSGAGSISYPARYANAMAVGATDQNNNRASFSQYGAGLDIVAPGVNVQSTYPGSTYASLNGTSMATPHVAGAAALVKQKNPSWSNVQIRNHLKNTATSLGSTNLYGSGLVNAEAATR

SEQ ID NO: 12 - protein, 382 aa, Alkalihalobacillus clausii
  PEPTIDE (1)..(382)
MMRKKSFWLGMLTAFMLVFTMAFSDSASAAEEAKEKYLIGFNEQEAVSEFVEQVEANDEVAILSEEEEVEIELLHEFETIPVLSVELSPEDVDALELDPAISYIEEDAEVTTMAQSVPWGIERVQAPAAHNRGLTGSGVKVAVLDTGISTHPDLRIRGGASFVPGEPSTQDGNGHGTHVAGTIAALDNSIGVLGVAPSAELYAVKVLGASGSGSVSSIAQGLEWAGNNGMHVANLSLGSPSPSATLEQAVNSATSRGVLVVAASGNSGAGSISYPARYANAMAVGATDQNNNRASFSQYGAGLDIVAPGVNILSTWPGSTYASLNGTSMATPHVAGAAALVKQKNPSWSNVQIRNHLKNTATSLGDTWEYGSGLVNAEAATR